(19) United States
(12) Patent Application Publication
(10) Pub. No.: US 2023/0223775 A1
(43) Pub. Date: Jul. 13, 2023

(54) Solar Powered Charging Assembly

(71) Applicant: Miguel Carrillo, Hereford, TX (US)

(72) Inventor: Miguel Carrillo, Hereford, TX (US)

(21) Appl. No.: 17/570,877

(22) Filed: Jan. 7, 2022

(51) Int. Cl. H02J 7/00

(52) U.S. Cl. CPC H02J 7/0045; H02J 7/0063; H02J 7/0068; H02J 2300/24

(57) ABSTRACT

A solar powered charging assembly for charging electronic devices includes a housing that has a plurality of charge ports each integrated into the housing to insertably receive a charge cord of an electronic device. Each of the charge ports is structurally unique with respect to each other to accommodate a respective one of a plurality of proprietary charge cords. A battery is positioned within the housing and the battery is in electrical communication with each of the charge ports to charge an electronic device when a charge cord for the electronic device is plugged into one of the charge ports. A solar panel is coupled to the housing and the solar panel is in electrical communication with the battery for charging the battery.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to charging devices and more particularly pertains to a new charging device for charging electronic devices. The device includes a housing with a variety of charge ports which can each receive a respective type of charge cord of an electronic device. The device includes a battery that is electrically coupled to each of the charge ports and a solar panel for charging the battery.

### (2) Description of Related Art Including Information Disclosed Under 37 CFR 1.97 and 1.98

The prior art relates to charging devices including a portable power bank that includes a case, a battery positioned in the case, a solar panel coupled to a lid of the case for charging the battery, a plurality of charge ports for charging an electronic device and an input port for charging the battery with an extrinsic power source. The prior art discloses a solar smart phone charger that includes a base with a plurality of charging wells for receiving an electronic device, a tower extending upwardly from the base which includes a plurality of solar panels for charging the electronic device. The prior art discloses a variety of solar chargers that each includes a plurality of hinged panels that are positionable in a deployed position for exposing solar panels on the hinged panels and a plurality of charge ports for charging at least one electronic device with the solar panels.

### BRIEF SUMMARY OF THE INVENTION

An embodiment of the disclosure meets the needs presented above by generally comprising a housing that has a plurality of charge ports each integrated into the housing to insertably receive a charge cord of an electronic device. Each of the charge ports is structurally unique with respect to each other to accommodate a respective one of a plurality of proprietary charge cords. A battery is positioned within the housing and the battery is in electrical communication with each of the charge ports to charge an electronic device when a charge cord for the electronic device is plugged into one of the charge ports. A solar panel is coupled to the housing and the solar panel is in electrical communication with the battery for charging the battery.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a solar powered charging assembly according to an embodiment of the disclosure.

FIG. 2 is a bottom phantom view of an embodiment of the disclosure.

FIG. 3 is a front view of an embodiment of the disclosure.

FIG. 4 is a left side phantom view of an embodiment of the disclosure.

FIG. 5 is a perspective in-use view of an embodiment of the disclosure.

### DETAILED DESCRIPTION OF THE INVENTION

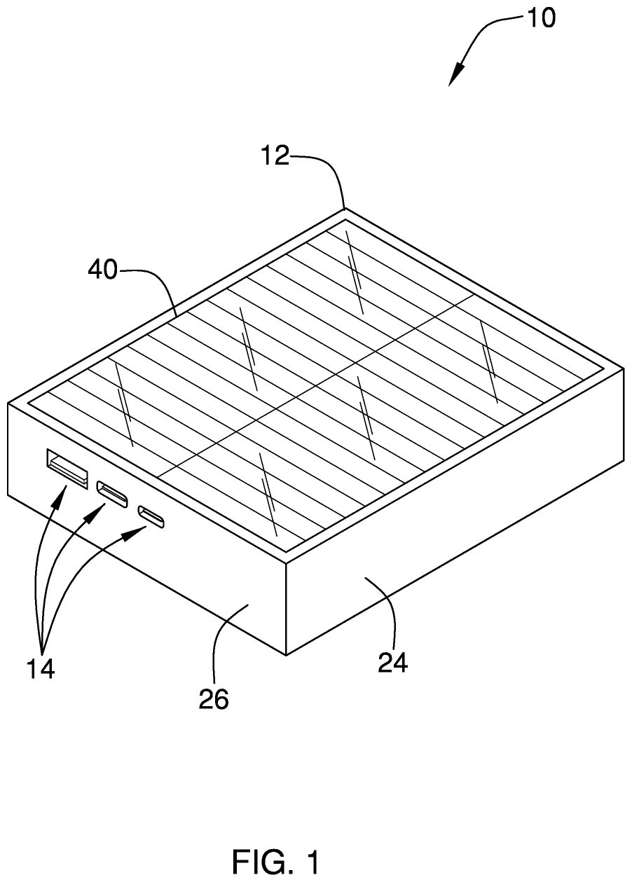

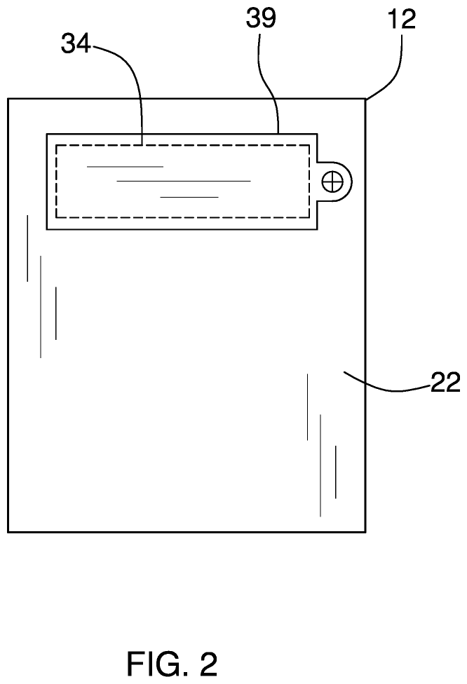

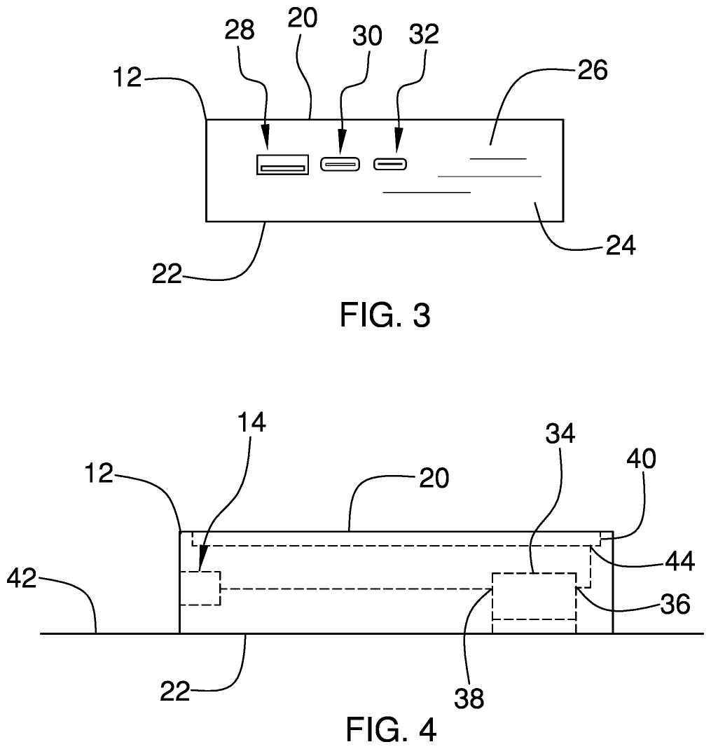

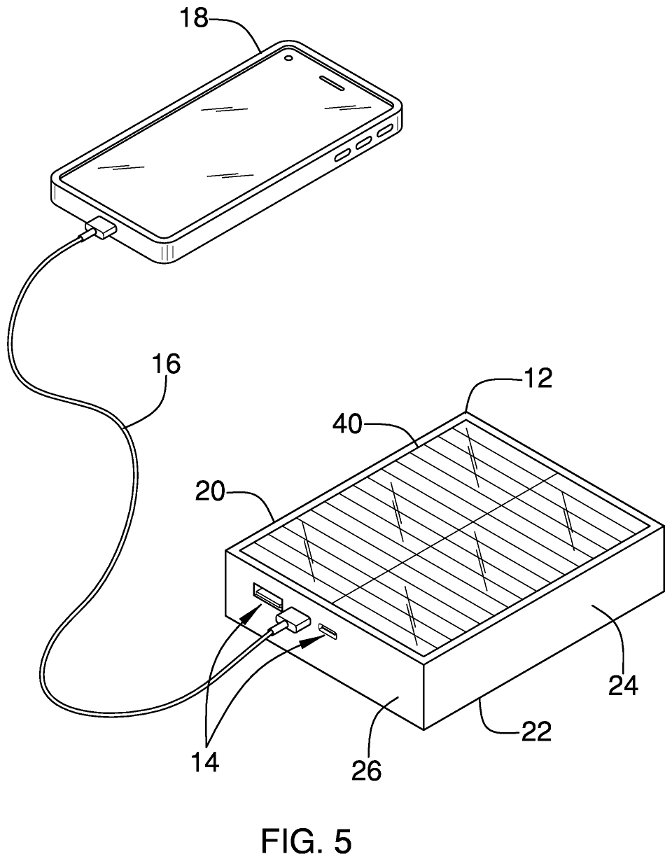

With reference now to the drawings, and in particular to FIGS. 1 through 5 thereof, a new charging device embodying the principles and concepts of an embodiment of the disclosure and generally designated by the reference numeral 10 will be described.

As best illustrated in FIGS. 1 through 5, the solar powered charging assembly 10 generally comprises a housing 12 that has a plurality of charge ports 14 each being integrated into the housing 12. Each of the charge ports 14 can insertably receive a charge cord 16 of an electronic device 18, such as a smart phone or other similar type of portable, electronic device. Each of the charge ports 14 is structurally unique with respect to each other such that each of the charge ports 14 can accommodate a respective one of a plurality of proprietary charge cords. The housing 12 has a top wall 20, a bottom wall 22 and a perimeter wall 24 extending between the top wall 20 and the bottom wall 22. The perimeter wall 24 has a front side 26, each of the charge ports 14 is recessed into the front side 26 and the charge ports 14 are spaced apart from each other and are laterally distributed on the front side 26. Additionally, the plurality of charge ports 14 includes a first charge port 28, a second charge port 30 and a third charge port 32. The first charge port 28 may comprise a universal serial bus port, the second charge port 30 may comprise a C-type port for charging an Android® device, and the third charge port 32 may comprise a firewire charge port for charging an Apple® device.

A battery 34 is positioned within the housing 12 and the battery 34 is in electrical communication with each of the charge ports 14. In this way the battery 34 can charge the electronic device 18 when the charge cord 16 for the electronic device 18 is plugged into one of the charge ports 14. The battery 34 has an input 36 and a plurality of outputs 38, and each of the outputs 38 is electrically coupled to a respective one of the first charge port 28, the second charge port 30 and the third charge port 32. The battery 34 may comprise a lithium ion battery or other type of rechargeable battery that is capable of being discharged and recharged multiple times over an extended duration of time. A battery cover 39 is removably attached to the bottom wall 22 of the housing 12 and the battery 34 is positioned beneath the battery cover 39 for removing the battery 34 from the housing 12.

A solar panel 40 is coupled to the housing 12 such that the solar panel 40 is exposed to sunlight. The solar panel 40 is in electrical communication with the battery 34 for charging the battery 34. The solar panel 40 is positioned on the top wall 20 of the housing 12 such that the top wall 20 directs the solar panel 40 upwardly when the bottom wall 22 is positioned on a horizontal support surface 42. The solar panel 40 has an output 44 and the output 44 of the solar panel 40 is electrically coupled to the input 36 of the battery 34.

In use, the housing 12 is positioned on the horizontal support surface 42 such that the solar panel 40 is directed upwardly thereby exposing the solar panel 40 to sunlight. In this way the solar panel 40 continuously recharges the battery 34. The charge cord 16 from a respective electronic device 18 is plugged into one of the charge ports 14 that matches the structure of the charge cord 16. In this way the electronic device 18 can be charged in any location regardless of whether there is access to electrical power.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A solar powered charging assembly for charging a personal electronic device in a remote area, said assembly comprising:
a housing having a plurality of charge ports each being integrated into said housing wherein each of said charge ports is configured to insertably receive a charge cord of an electronic device, each of said charge ports being structurally unique with respect to each other wherein each of said charge ports is configured to accommodate a respective one of a plurality of proprietary charge cords;
a battery being positioned within said housing, said battery being in electrical communication with each of said charge ports wherein said battery is configured to charge an electronic device when a charge cord for the electronic device is plugged into one of said charge ports; and
a solar panel being coupled to said housing wherein said solar panel is configured to be exposed to sunlight, said solar panel being in electrical communication with said battery for charging said battery.

2. The assembly according to claim 1, wherein said housing has a top wall, a bottom wall and a perimeter wall extending between said top wall and said bottom wall, said perimeter wall having a front side, each of said charge ports being recessed into said front side, said charge ports being spaced apart from each other and being laterally distributed on said front side, said plurality of charge ports including a first charge port, a second charge port and a third charge port.

3. The assembly according to claim 2, wherein said battery has an input and a plurality of outputs, each of said outputs being electrically coupled to a respective one of said first charge port, said second charge port and said third charge port.

4. The assembly according to claim 2, wherein:
said battery has an input; and
said solar panel is positioned on said top wall of said housing wherein said top wall is configured to direct said solar panel upwardly when said bottom wall is positioned on a horizontal support surface, said solar panel having an output, said output of said solar panel being electrically coupled to said input of said battery.

5. A solar powered charging assembly for charging a personal electronic device in a remote area, said assembly comprising:
a housing having a plurality of charge ports each being integrated into said housing wherein each of said charge ports is configured to insertably receive a charge cord of an electronic device, each of said charge ports being structurally unique with respect to each other wherein each of said charge ports is configured to accommodate a respective one of a plurality of proprietary charge cords, said housing having a top wall, a bottom wall and a perimeter wall extending between said top wall and said bottom wall, said perimeter wall having a front side, each of said charge ports being recessed into said front side, said charge ports being spaced apart from each other and being laterally distributed on said front side, said plurality of charge ports including a first charge port, a second charge port and a third charge port;
a battery being positioned within said housing, said battery being in electrical communication with each of said charge ports wherein said battery is configured to charge an electronic device when a charge cord for the electronic device is plugged into one of said charge ports, said battery having an input and a plurality of outputs, each of said outputs being electrically coupled to a respective one of said first charge port, said second charge port and said third charge port; and
a solar panel being coupled to said housing wherein said solar panel is configured to be exposed to sunlight, said solar panel being in electrical communication with said battery for charging said battery, said solar panel being positioned on said top wall of said housing wherein said top wall is configured to direct said solar panel upwardly when said bottom wall is positioned on a horizontal support surface, said solar panel having an output, said output of said solar panel being electrically coupled to said input of said battery.

6. A solar powered charging system for charging a personal electronic device in a remote area, said system comprising:
a plurality of electronic devices, each of said electronic devices having a proprietary charge cord with respect to each other;
a housing having a plurality of charge ports each being integrated into said housing to insertably receive said charge cord of a respective one of said electronic devices, each of said charge ports being structurally unique with respect to each other to accommodate said proprietary charge cord of a respective one of said electronic devices, said housing having a top wall, a bottom wall and a perimeter wall extending between said top wall and said bottom wall, said perimeter wall having a front side, each of said charge ports being recessed into said front side, said charge ports being spaced apart from each other and being laterally distributed on said front side, said plurality of charge ports including a first charge port, a second charge port and a third charge port;
a battery being positioned within said housing, said battery being in electrical communication with each of said charge ports to charge said electronic device when said charge cord for said electronic device is plugged into one of said charge ports, said battery having an input and a plurality of outputs, each of said outputs being electrically coupled to a respective one of said first charge port, said second charge port and said third charge port; and
a solar panel being coupled to said housing wherein said solar panel is configured to be exposed to sunlight, said solar panel being in electrical communication with said battery for charging said battery, said solar panel being positioned on said top wall of said housing wherein said top wall is configured to direct said solar panel upwardly when said bottom wall is positioned on a horizontal support surface, said solar panel having an output, said output of said solar panel being electrically coupled to said input of said battery.
